(19) United States
(12) Patent Application Publication
(10) Pub. No.: US 2010/0228679 A1
(43) Pub. Date: Sep. 9, 2010

(54) Hardware Unit-Based License Management Method

(75) Inventor: James R. Scapa, Wixom, MI (US)

Correspondence Address: YOUNG BASILE, 3001 WEST BIG BEAVER ROAD, SUITE 624, TROY, MI, 48084, US

(73) Assignee: ALTAIR ENGINEERING, INC., Troy, MI (US)

(21) Appl. No.: 12/753,228

(22) Filed: Apr. 2, 2010

Related U.S. Application Data
(63) Continuation-in-part of application No. 11/061,166, filed on Feb. 21, 2005.
Application No. 11/061,166 is a continuation-in-part of application No. 09/855,317, filed on May 15, 2001, now Pat. No. 7,672,972.
(60) Provisional application No. 61/166,036, filed on Apr. 2, 2009.

(51) Int. Cl. G06Q 50/00; G06Q 99/00; G06Q 10/00; G06F 15/16

(52) U.S. Cl. 705/310; 709/229

(57) ABSTRACT

Disclosed herein is a method for licensing at least one hardware resource for use by a customer computer, the at least one hardware resource provided by an application service provider (ASP) distinct from the customer computer. The method includes providing licensed units to a customer, assigning a predetermined number of ASP assigned hardware units to the at least one hardware resource, and determining whether the customer can utilize the at least one hardware resource using the licensed units provided to the customer and the ASP assigned hardware units for the assigned to the at least one hardware resource.

### CROSS-REFERENCE TO RELATED APPLICATIONS

This application claims priority to U.S. Provisional Patent Application No. 61/166,036, filed Apr. 2, 2009.

This application is also a continuation-in-part of U.S. patent application Ser. No. 11/061,166, filed Feb. 21, 2005, which is in turn a continuation-in-part of U.S. Pat. No. 7,672,972, issued Mar. 2, 2010, all of which are incorporated herein by reference in their entirety.

### FIELD OF THE INVENTION

This disclosure relates, in general, to license management methods suitable for licensing the usage of hardware resources/components.

### BACKGROUND

Although computer programs, individually also referred to as computer software products, can be sold to an end user, a more frequent approach is to license the software product or program to an end user, with the software vendor or owner retaining ownership of all of the rights to the computer product.

Each license is devised to control the usage of the computer product or software by stating the conditions under which the computer product may be used, such as the location of use, the number of times used, etc. Software products are licensed in many ways. By one category, licenses can be divided into node-locked licenses or network licenses. By another category, licenses can be divided into product licenses or product suite licenses. In general most licenses could be described by a combination or a simple variation thereof of the above two categories; i.e. node-locked product licenses, node-locked product suite licenses, network product licenses, and network product suite license.

Node-locked licenses restrict the use of software to a given computer. The major limitation of this approach is that it requires customer to purchase software separately for each potential user. Since each user does not use each software program on his machine all the time, software purchased via this approach would idle most of the time. This is a very inefficient use of customers' money.

Network licenses allow access to the software products on computer networks formed of a number of interconnected computers or nodes which may be linked to each other and/or a central host. This addresses the primary inefficiency of node-locked licenses. The customer must now purchase licenses only to cover the anticipated number of peak simultaneous users of that software.

Product licensing restricts the use of the license to only the product for which it is valid. In other words, the license is not transferable to other products. The limitation of this approach is that a customer must purchase the peak licenses, either node-locked or network, for each product separately. Again, peak usage for different products does not occur at the same time. Hence, the customer ends up purchasing more software licenses than really required.

Product suite licenses allow access to several software products using common licenses. A suite would generally include several individual programs which may be run concurrently with each other, or individually, and may or may not be linked to other programs in the suite. Traditional licensing approaches for computer programs or suites typically involve one license for all of the programs in each entire suite such that a user on a node of a computer network is charged with one license use regardless of which program the user is running from a particular program suite. A major limitation of this approach is that it assumes that each product in the suite has an equal value. Also, product suites typically involve a small number of software products which complement each other, and the expansion of suite licensing to license a wide range of software products is commercially impractical.

A recent development in licensing has been the units-based licensing of multiple products. In such a system, different products are assigned different values in terms of units. A customer would license a certain number of units to run any and all of these products. While on paper, this system appears to address limitations listed above, in reality it does not due to the manner in which it is implemented by several organizations. Under this setup, when a user runs multiple products, the user is charged multiple units, also called stacking of units. Since the customers have limited budgets for purchasing software products, this system (i) forces the users to terminate one product in order to run another, thus decreasing the user's efficiency, or (ii) forces the customer to purchase additional licenses with no additional value thus undermining the profitability of their organization. This system does not encourage users to try new products, even though they are accessible and available on their network.

Although existing software or electronic media licensing systems allow or deny access to a requesting user to execute or run an electronic media or software program on a computer or computer network, frequently the computer or computer network does not have sufficient capacity to immediately run the program, software or electronic media. Normally, a small capacity processor would be completely adequate in instances where there are a small number of users requesting access to the processor or such access is requested infrequently. However, it may become necessary to expand the memory or disk space, or to increase the processor speed, to name a few factors, when more users are added to the network, where the computer products or applications are run more frequently, where the size of an application increases, etc. For example, a few years ago, a full vehicle model consisted of approximately 100,000 discrete points. Currently, vehicle models contain 500,000 discrete points and are heading towards 1,000,000 discrete points thereby increasing the application size by an order of magnitude.

Cost factors may dictate that a particular computer or computer network owner would not always wish to immediately expand the capacity or speed of its computer or computer network. This is particularly the case where there may be short-lived bursts in application execution or user access which are not expected to occur in the future. Another factor is that in the dynamic consumer electronic medium industry, current technology is updated or obsolete in a matter of months. A particular consumer would prefer not to install and un-install software products on his/her computer on a recurring basis. Rather, the consumer would prefer to just use the software. Further, new versions of software products or digital media come out very frequently. Bug fixes and patches are delivered almost on a continual basis. A consumer or digital content user does not always receive or install fixes or patches. Further, a business consumer may not wish to maintain a computer server and employ information technology people to manage it. A business consumer may also wish to provide a customer with the choice of products for a set budget. A business consumer may further wish to provide a customer with the flexibility to transfer licenses from one product to another. While application service providers' processors at a remote location have been used to temporarily run an application program which cannot be run on an existing computer or computer network due to overcapacity, etc., licensing approaches have not extended to cover such remote application service provider execution.

### SUMMARY

Disclosed herein are embodiments of a method for licensing at least one hardware resource for use by a customer computer where the at least one hardware resource is provided by an application service provider (ASP) distinct from the customer computer. In one such embodiment, the method includes providing licensed units to a customer. The method also includes assigning a predetermined number of ASP assigned hardware units to the at least one hardware resource. Further, the method includes determining whether the customer can utilize the at least one hardware resource based on the licensed units provided to the customer and the ASP assigned hardware units for the assigned to the at least one hardware resource.

Also, embodiments of a licensing method for use in a customer computer network (CCN) having at least one node capable of executing digital content on at least one of the CCN and an application service provider (ASP) where the ASP provides at least one hardware resource are also disclosed herein. In one such embodiment, the method includes providing licensed units to a customer and assigning a predetermined number of ASP assigned hardware units to the at least one hardware resource. The method also includes charging a number of checked out units to the CCN based on ASP hardware resources currently being utilized by the customer and receiving a request to utilize a hardware resource provided by the ASP. Further, the method includes determining a number of available units equal to the difference between the total licensed units to the customer and the total checked out units charged to the CCN and determining whether the requested hardware resource is to be utilized based on the difference between the available units on the customer computer network requesting the hardware resource and ASP assigned hardware units of the requested hardware resource.

Further, embodiments of a licensing method for use in a customer computer network having at least one node capable of executing digital content on at least one of the customer computer network (CCN) and an application service provider (ASP) providing at least one hardware resource are disclosed herein. In one such embodiment, the method includes providing licensed units to a customer and providing independently selectable digital content. The method also includes assigning a predetermined number of ASP assigned hardware units to the at least one hardware resource and charging a number of checked out units to the CCN at least based on ASP hardware resources currently being utilized to run digital content on the ASP. Further, a request is received to utilize a hardware resource provided by the ASP to execute a selected digital content. The method also includes determining a number of available units equal to the difference between the total licensed units to the customer and the total checked out units charged to the CCN and determining whether the requested hardware resource is to be utilized or denied utilization based on the difference between the available units on the customer computer network requesting the hardware resource and the ASP assigned hardware units of the requested hardware resource.

These and other embodiments will be described in additional detail hereinafter.

### BRIEF DESCRIPTION OF THE DRAWINGS

The various features, advantages and other uses of the present invention will become more apparent by referring to the following detailed description and drawing in which:

FIG. 1 is a pictorial representation of a network having a communication network coupled to a computer network and application service provider;

FIG. 2 is a flow diagram depicting operation of a licensing management method that can be used in the network of FIG. 1;

FIG. 3 is a pictorial representation of an alternate computer network and application service provider using a licensing management method;

FIG. 4 is a pictorial representation of an alternate network having a communication network coupled to a computer network and application service provider network using an alternate licensing management method usable for licensing computer components or hardware and/or digital content; and

FIGS. 5A and 5B are pictorial representations of two alternate aspects of a licensing method showing the flow of units/tokens between the licensed units pool and customer checked out units.

### DETAILED DESCRIPTION

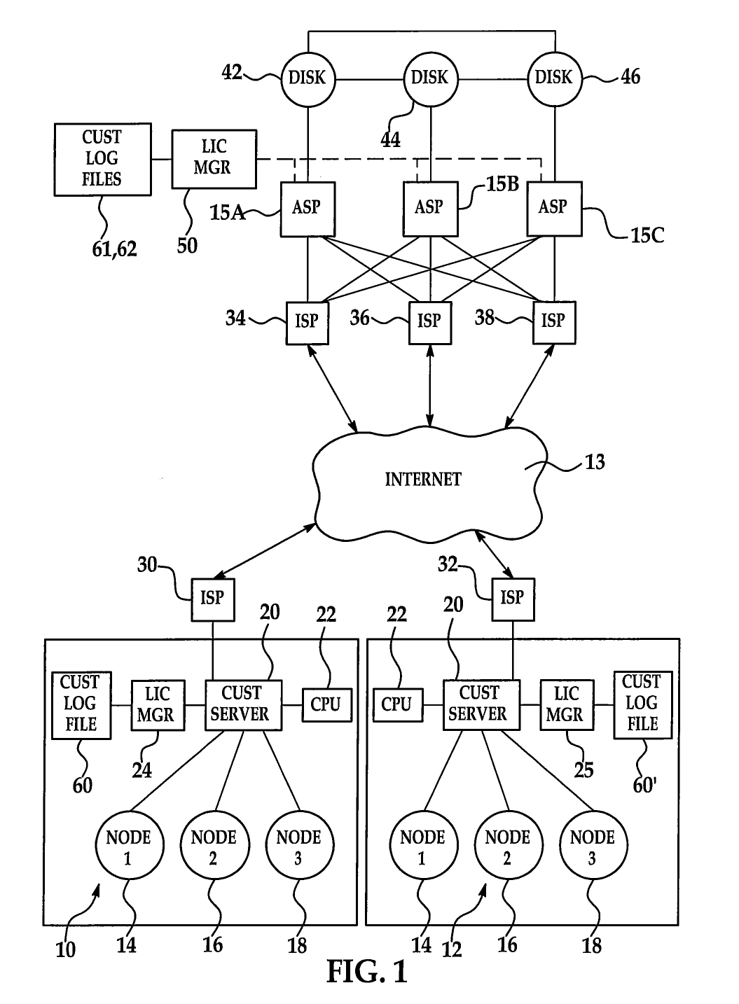

Referring to FIG. 1, there is depicted a computer communications network containing at least one customer computer network 10 and, preferably, a plurality of customer computer networks 10, 12, etc. which can independently communicate through a communications network 13, such as the Internet, with one or more remotely located application service provider (ASP) networks 15A, 15B, 15C.

By way of example only, the customer computer networks 10 and 12 each include at least one and, optionally a plurality of individual nodes, with three nodes 14, 16, and 18, being depicted by way of example only in networks 10 or 12. Each of the nodes 14, 16, and 18 is connected to a network server 20 and has its own network address so that any one of the nodes 14, 16 and 18 can communicate with the each other node 14, 16, and 18 within the network 10 or 12. The network server 20 is connected in data communication with a host CPU 22.

Although the individual nodes 14, 16, and 18 are depicted as being connected in a spoke configuration to the network server 20, it will be understood that this arrangement is by example only as the individual nodes 14, 16, and 18 may be connected in a ring configuration or any other configuration found in computer networks. Further, the network server 20 and the host CPU 22 may be combined into a single computer.

As will be clearly understood by those in the computer art, each of the nodes 14, 16, and 18, as well as the network server 20 and the host CPU 22, may be formed of a conventional central processing unit (CPU), such as a microprocessor, as well as standard computer components coupled to the CPU, including a memory, input components, such as a keyboard, etc., and output components, such as a screen display, printer, etc., not shown.

For explanatory purposes only, a node is defined as a unique combination of a user, or a CPU or host, or a display, or a user and a CPU, or a CPU and a display, or a user and a display, or a user, a CPU and a display.

A license manager 24 is embodied in a software program which may be resident or stored in the memory of the network server 20 or the host CPU 22 and/or capable of being stored in a storage media, such as a disk, CD-ROM, etc. The license manager 24 may also be resident or stored in the memory of a separate central processing unit or microprocessor which is coupled to the network server 20 or the host CPU 22.

The function of the license manager 24, as described in greater detail hereafter, is to control access to, as well as monitor, the execution or running of one or more pieces of individual digital content or media coupled together or sold as a suite or even sold or licensed individually. The suite is formed of a plurality of individual digital content which may be separately executable or executable in multiple numbers, and is resident in the memory of and/or a hard drive connected to the host CPU 22. In this arrangement, the network server 20 merely distributes an authorized licensed program from the suite to the requesting node.

The term “digital content” as used herein means any type of electronic or digital content or media which can be executed or run by a computer processor. Thus, “digital content” includes computer software in the form of application programs, operating systems, etc., as well as digital content for audio, video, audio/video executable files. Further, the term “digital content” as used with the present licensing method further includes digital data or digital files which can be processed by other application programs or require execution by other software and/or hardware, such as a music player, etc.

Before describing the details of the inventive licensing method, certain terms will first be defined:

Licensed Units: The total number of units licensed by a customer on a customer computer network.

Customer Computer Network (CCN) Assigned Units: The value in terms of units assigned to each discrete digital content in the product suite licensed by one customer for execution on the customer computer network.

Application Service Provider (ASP) Assigned Units: The value in terms of units assigned to each discrete digital content in the product suite licensed by one customer for execution on an application service provider.

Customer Computer Network (CCN) Node Running Total: The total number of units checked out by one node on the customer computer network at a given time. In a leveling licensing arrangement on the customer computer network, the CCN node running total is equal to the product or digital content having the highest CCN assigned units value of all of the products or digital content executed by the one CCN node at one given time. In a stacking licensing arrangement, the CCN node running total is equal to the total of the CCN assigned units of all of the products or digital content executed by the Application Service Provider (ASP) Node Running Total The total number of units checked out by one ASP node on the application service provider at a given time. In a leveling licensing arrangement on the application service provider the ASP node running total is equal to the product or digital content having the highest ASP assigned units value of all of the products or digital content executed or locked for later execution by the one node at one given time. In a stacking licensing arrangement, the ASP node running total is equal to the total of the ASP assigned units of all of the products or digital content executed or locked for later execution by the one node on the ASP computer network.

Customer Computer Network (CCN) Checked Out Units: The sum of node running totals of all nodes on the customer computer network.

Application Service Provider (ASP) Checked Out Units: The sum of node running totals of all nodes on the application service provider for one customer.

Total Checked Out Units: The sum of the CCN checked out units and the ASP checked out units.

Available Units: Licensed units minus total checked out units.

Customer Computer Network (CCN) Required Units: Number of units required to start a new product or digital content run by one node on one customer computer network. In a leveling licensing arrangement, if the CCN assigned units for the new product or digital content are greater than the CCN node running total, the CCN required units equals the CCN assigned units of the new product minus the CCN node running total. If the CCN assigned units for the new product or digital content are less than or equal to the CCN node running total, then the CCN required units equals zero. In a stacking licensing arrangement, the CCN required units equals the number of CCN assigned units for the new product or digital content.

Application Service Provider (ASP) Required Units: Number of units required to start a new product or digital content run by one node on an application service provider. In a leveling licensing arrangement, if the ASP assigned units for the new product or digital content are greater than the ASP node running total, the ASP required units equals the ASP assigned units of the new product minus the ASP node running total. If the ASP assigned units for the new product or digital content are less than or equal to the ASP node running total, then the ASP required units equals zero. In a stacking licensing arrangement, the ASP Required Units are the number of ASP assigned units for the new product or digital content.

Customer Computer Network (CCN) Returned Units: Number of units returned to the available units when a product or digital content is terminated by one node on the customer computer network. In a leveling licensing arrangement, if the CCN assigned units of the terminated product or digital content are less than the CCN node running total, then the CCN returned units equals zero. If the CCN assigned units for the terminated product are equal to the CCN node running total, then the CCN returned units equals the CCN assigned units for the terminated product minus the next highest CCN assigned units value of the remaining products or digital content running on the node. In a stacking licensing arrangement, the CCN returned units equals the CCN assigned units of the content terminated on the customer computer network.

Application Service Provider (ASP) Returned Units: Number of units returned to the available units when a product or digital content is terminated by one node on the application service provider. In a leveling licensing arrangement, if the ASP assigned units of the terminated product or digital content are less than the ASP node running total, then the ASP returned units equals zero. If the ASP assigned units for the terminated product are equal to the ASP node running total, then the ASP returned units equals the ASP assigned units for the terminated product minus the next highest ASP assigned units value of the remaining products or digital content running on the node. In a stacking licensing arrangement, the ASP returned units equals the ASP assigned units of the content terminated on the application service provider.

Each piece of digital content in a program suite licensed to a particular customer computer network, such as customer computer network 10 and 12, is provided with two separate assigned units, such as the CCN assigned units and the ASP assigned units defined above. The actual number of assigned units assigned to each discrete digital content in the program suite can be arbitrarily chosen, and the number of assigned units for two or more pieces of digital content can be identical or different.

By way of example only, the number of assigned units assigned to each piece of digital content is selected as a function of one license price of each product or program divided by an arbitrary factor. By example only, the least price of each discrete digital content or digital product is divided by $250 to yield the number of assigned units assigned to each piece of digital content. It will also be understood that the number of assigned units assigned to each digital content may also be based on the size of the individual products, the amount of time typically employed to run each digital content, or its inherent value to an end user in a particular application.

The above described assigning of units for each piece of digital content in the program suite can be further understood by referring to U.S. Pat. No. 6,859,792, and entitled PRODUCT SUITE LICENSING METHOD, the entire contents of which is incorporated herein by reference. This patent describes a licensing method based on a unique leveling concept for controlling the licensing of products for digital content in a product suite in a single computer network.

It will be understood that the present digital content licensing method is directed toward the execution of licensed digital content on the customer's own computer network and/or on an application service provider at the selection of a customer. Thus, the customer has the option of:

1. running all licensed digital content on its own computer network;
2. running some digital content on its own computer network and some digital content on the ASP network;
3. running a portion of one piece of digital content on its own computer network and a portion of the same piece of digital content on the ASP network; or
4. running all licensed digital content on the ASP network.

Thus, the present licensing method requires input from the license manager 24 of the customer computer network 10 to determine the customer computer network checked out units of digital content currently being executed by the customer on the customer computer network 10 in conjunction with ASP checked out units for digital content currently being executed on the application service provider 15A, 15B, or 15C for the customer computer network 10.

The ASP assigned units for each piece of digital content in the product suite licensed to the customer computer network 10 can be the same as the CCN assigned units for the same piece of digital content when the digital content is executed on the customer computer network 10. However, preferably, the ASP assigned units for each piece of digital content which is executable at the selection of a customer on the customer computer network 10 or 12 or on a remote application service provider 15A, etc., is a different than the CCN assigned units for the same piece of digital content.

The ASP assigned units for each individual product in the product suite may be calculated or preset according to any one of a number of different methods:

1. A fixed percentage difference of the CCN assigned units of each product at each individual customer, such as a fifty percent surcharge of each of the CCN assigned units of the products in the product suite.
2. A variable percentage difference of the CCN assigned unit value of each product in the product suite which is selected according to any one of a number of different criteria, including, for example, frequency of usage, individual product costs, product length in terms of required memory, storage, special processing factors, etc.
3. A flat difference of a fixed number of units, such as sixty units, in addition to the CCN assigned units for each product in the product suite.
4. A different flat rate for each individual product based on any one or more of various criteria including frequency of use, perceived value to the customer, product cost, etc.

The number of ASP assigned units may also be variable on a time of day or time of week basis, with the ASP assigned units for digital content which are executable during selected periods of the day or week in which the ASP 15A, etc., normally is underutilized, such as during the night, or on weekends, for example, can be different than the ASP assigned units for the same piece of digital content when executed during normal business hours during the week.

It will also be understood that the ASP assigned units, calculated according to any one of the above methods, may also be implemented in a license strategy in different ways, including the previously described leveling approach, a simple stacking approach, or combinations thereof.

In a leveling approach, for example, the ASP required units for execution of a requested product from the product suite by one of the nodes on the customer computer network 10 will be treated the same as when the individual node requests access to one of the products in product suite stored on the customer server 20 except that the ASP assigned units will be one of the above described ASP assigned units. Calculation of the ASP required units for the requesting node will be according to the leveling method described in U.S. Pat. No. 6,859,792, entitled PRODUCT SUITE LICENSING METHOD, and will be used to determine access or denial of access to the requested program on the ASP 15A, etc.

In a stacking approach, for example, the ASP required units for execution of a requested product from the product suite by one of the nodes on the customer computer network 10 will be treated the same as when the individual node requests access to one of the products in product suite stored on the customer server 20 except that the ASP assigned units will be one of the above described ASP assigned units. Calculation of the ASP required units for the requesting node will be according to the stacking method described in the above-referenced US patent application and will be used to determine access or denial of access to the requested program on the ASP 15A, etc.

It should be noted that the present digital content licensing method makes use of the available number of units on the customer computer network 10 in determining whether or not a particular piece of digital content selected by the customer computer network 10 is to be executed on the application service provider 15A, 15B, etc. Thus, the specific licensing method deployed by license manager 24 on the customer computer network 10 can use any suitable licensing arrangement, such as a conventional stacking license arrangement, a leveling licensing arrangement as in the above-referenced application, combinations thereof, etc.

Each customer computer network 10 or 12 communicates with the data communication network 13 through an Internet service provider or ISP 30, 32, respectively. In addition, the data communication network or Internet 13 in the present invention communicates with one or more application service providers 15A, 15B, 15C through Internet service providers 34, 36 and 38, respectively. Although a single ISP 34 and a single ASP 15A may be employed for communicating with one or more customer computer networks 10 and 12, for further flexibility and to insure a faster response time and an execution or run of individual digital content on the application service provider for any of the customer computer networks 10 or 12, the plurality of ISPs 34, 36 and 38 are each connectable to one or more ASPs 15A, 15B, 15C. Each ASP 15A, 15B and 15C may also be connected to memory storage media, such as one or more disks 42, 44 and 46. Each ASP 15A, 15B and 15C can access each of the disks, 42, 44 and 46 to obtain data or digital content stored on the disks 42, 44, and 46.

An ASP license manager 50 is connected to each of the ASPs 15A, 15B and 15C. Initially, the customer computer network license manager 24 recognizes the total number of licensed units purchased or made available in the customer server 20. This total number of licensed units can be paid in any of a number of ways, each primarily based on a license term or period, such as one year, for example only. The license royalty or fee will be based on a certain price per license unit, such as $250 per license unit in the above example. However, the number of licensed units purchased by this license fee covers the complete license term, such as one year, for example, and acts as a cap limiting the number of individual programs or products, as described hereafter, which can be executed or run simultaneously on the customer computer network 10 and the ASP network 15A, etc. To state this another way, the total checked out units at a given time cannot exceed the number of licensed units paid for by the licensee or entity controlling the network 10.

The licensed units which are purchased by a particular customer can come in a number of different forms. In one form, all of the licensed units are treated the same and useable both on the customer computer network 10 or 12 as well as the ASP network 15A, etc. In this manner, the customer may execute digital content on either its own customer computer network 10 or the ASP 15A, 15B, etc., and use the licensed units for either network. Second, the licensed units may be in two varieties, namely, customer computer network licensed units and ASP network licensed units. This leads to several variations including the customer computer network licensed units being useable only on the customer computer network and the ASP licensed units useable only on the ASP network, or the customer licensed units being useable on both the customer computer network and the ASP computer network, but the ASP licensed units being useable only on the ASP network, or the customer licensed units being useable only on the customer computer network and the ASP licensed units being useable on both the customer computer network and the ASP network.

In addition to the same or different licensed units for execution of digital content on the customer computer network and the application service provider network 15A, 15B, etc., the product suite of programs available on the customer computer network may be the same or different from the product suite of products or digital content which is available for run or execution on the application service provider network 15A, 15B, etc. For example, the digital content available on the customer computer network may be identical to the digital content available for execution on the application service provider network. Alternately, the application service provider network may contain more or less digital content than that available to the same customer on the customer computer network. Further, the customer computer network and the ASP network may have some of the same digital content and may also each have different digital content which is executable separately on the customer computer network or the application service provider network, respectively, and not vice-versa.

A customer log file 60 is maintained by the license manager 24 for the customer computer network 10 and a customer log file 60′ by the license manager 25 for the customer computer network 12. The customer log file 60 or 60′ contains the total number of available units which can be used at the customer computer network 10 or 12 and/or on an application service provider 15A, etc., at any given time. The license manager 24 for the customer computer network 10 will update the customer log file 60 for each change of the available units on the customer computer network 10. As described hereafter, such a change in the available units on the customer computer network 10 results from the execution of additional products from the program suite or the termination of the execution of one of the products in the suite either on the customer computer network 10, 12, or on the ASP computer network 15A, 15B, etc.

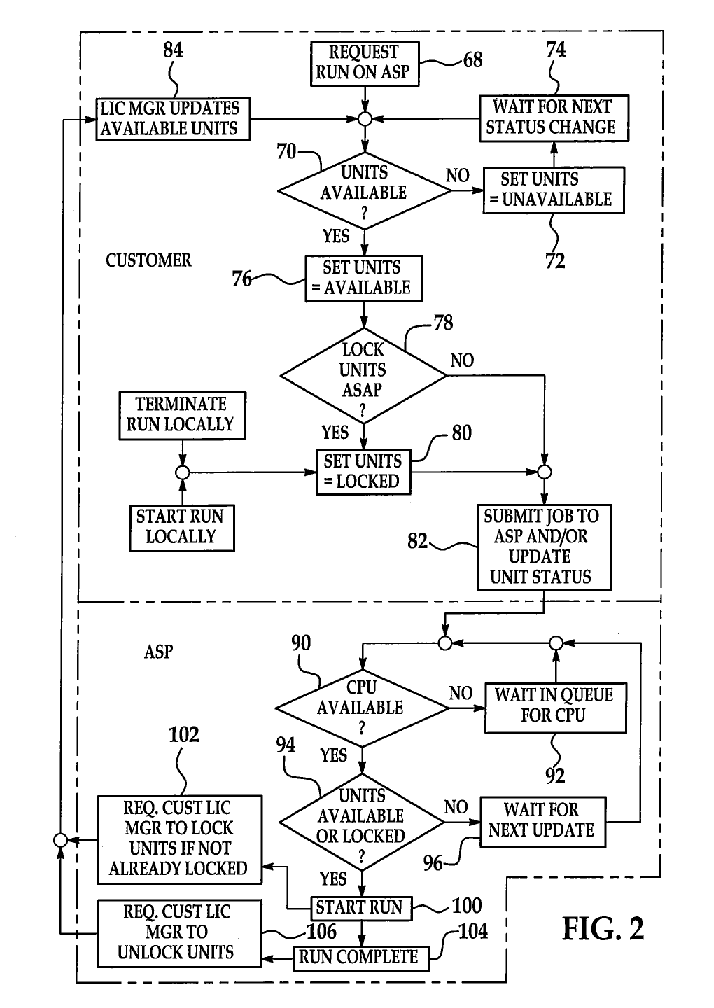

A customer may execute any of the digital content on its local customer computer network 10 or 12 based on the determination by the license manager 24 or 25, respectively, whether the number of available units is sufficient to execute the next requested digital content on the respective customer computer network 10 or 12. However, for the reasons set forth above, the customer, such as the customer using the customer computer network 10, may decide to execute a piece of digital content on the ASP network, 15A, etc. As shown in FIG. 2, the customer computer network 10 initially requests a run or execution of digital content on the ASP 15A, 15B, 15C, etc., in step 68 by sending the request through its ISP 30 and the data communication network 13 to the ASP network, 15A, 15B, etc. However, before the run is initiated, the license manager 24 first determines in step 70 if a sufficient number of units is available for executing the requested digital content on the ASP network. This available unit count is obtainable from the customer log file 60 or customer log file 60′ for the customer computer network 12.

If the available units in the customer log file 60, for example, are insufficient for the ASP 15A, etc., to execute the requested digital content, the license manager 24 sets a flag “units=unavailable” in step 72, and the status is logged in step 82 for further processing.

However, if a sufficient number of units is available for executing the requested digital content, the license manager 24 sets a flag “units=available” in step 76 and then makes a determination in step 78 whether the user has asked to lock or not lock the units at this time. If the user has asked not to lock the units at this time, the flag remains set at “units=available”, and the status is logged in step 82 for further processing. However, if the user has asked to lock the units, the license manager in step 80 sets a flag “units=locked.”, and the status is logged in step 82 for further processing and asks the license manager 24 to check out the units.

The license manager in step 84 communicates the unit status logged in step 82 at regular intervals, such as every 1 minute or 15 minutes, for example, to the ASP 15A, etc., or when the status is updated in steps 72, 76 or 80 and logged in step 82.

If the status is “units=locked”, the requested content will run on the ASP computer network 15A, etc. as soon as a CPU becomes available on the ASP network. However, regardless if the status is “units=available” or “units=unavailable”, the status may change depending on the activities on the customer computer network 10, 12 or the ASP computer network 15A, 15B, etc. Hence, in addition to logging the status on to step 82, steps 72 and 78 also loop the control back to step 74 so that step 70 will be re-evaluated and the units status may be changed from “available” to “unavailable” or vice versa depending upon the change in availability of units in step 76, or a change in CPU status from available to unavailable, or a second or later queued content may be executed instead of the first queued request.

As shown in FIG. 2, the license manager 24 updates the available units in the customer log file 60 upon any of the following events:

1Termination of a local run on the customer computer network 10;
2. The setting of “units=locked” flag in step 80;
3. The start of an execution or run of a piece of digital content on the customer computer network 10;
4. A request from an ASP 15A, 15B, etc., to lock units if not already locked; and
5. A request from one of the ASP 15A, 15B, etc. to release units at the termination of a run or execution of a piece of digital content on the ASP 15A, 15B, etc.

Thus, it can be seen that the number of available units in the customer log file 60 can be a dynamically changing number dependent upon execution of digital content on the customer computer network 10 and a choice by the customer computer network 10 to execute pieces of digital content on the ASP 15A, 15B, etc. The execution, locking or unlocking of units and the termination of execution of any piece of digital content on the customer computer network 10 or the ASP network, 15A, 15B, etc., causes the number of available units to increase or decrease accordingly.

Referring back to FIG. 2, after step 82 is completed, control now transfers to the license manager 50 for the ASP network 15A, 15B, etc., for step 90. The license manager 50 makes a determination in step 90 if an ASP CPU is available to execute the requested digital content. If a CPU is unavailable, the run request is controlled by the ASP license manager 50 and is a sequential ordering of digital content awaiting an available CPU on the ASP network, 15A, 15B, etc.

If a CPU is available as determined in step 90, the license manager 50 makes a determination in step 94 if the unit's status is “locked”, “available” or “unavailable”. If the status is “unavailable”, step 96 is executed wherein the license manager 50 waits for the next unit status update in steps 82 and 84 from the customer computer network 10, or the license manager 50 regarding the status of CPUs

If the status was “available” or “locked”, the ASP network 15A, 15B, etc., starts the execution in step 100. Simultaneously, the ASP network 15A, 15B, etc., requests in step 102 the customer license manager 24 to lock the units required to execute the requested piece of digital content if not already locked in step 80. This causes the license manager 24 to readjust the available units in the customer log file 60.

Next, upon the completion of the run or execution of the digital content in step 104, the ASP 15A, etc. in step 106, requests the customer license manager 24 to unlock the units according to which digital content is terminated. This request is honored by the license manager 24 which adds the units in the customer log file 60 to reflect the terminated digital content on the ASP 15A, etc. The completion of the run or execution of the digital content in step 104 also updates the status of available CPUs, thus triggering the decision process for choosing the next job for execution.

The license manager 50 controls and monitors all jobs queued, whether due to unavailability of a CPU or due to the unavailability of units, as follows. As and when a CPU becomes available due to termination of a job in step 104, the license manager 50 would check the first job in the queue for its unit's status in step 94. If units are “available” or “locked”, that job will be executed as described earlier. If units were “unavailable”, the job will be returned back to the queue and marked as “returned”. The license manager will now check the next job in the queue for its unit's status. It will continue to check jobs in the queue until it finds a job with unit's status of “locked” or “available”, or there are no more jobs left to check in the queue. The license manager 50 may also be designed such that a “returned” job would retain its original position, or it is sent to the bottom of the queue, or it is demoted by a certain number of spots in the queue. Also, if a job is flagged “returned” a certain number of times, say 3 times for example, and is waiting in the queue for a certain number of hours, say 6 hours for example, the license manager may be designed to delete the job from the queue altogether.

Another situation may arise using the communication network, customer computer network and application service provider network shown in FIG. 1. For example, if one of the users on the customer computer network 10 desires to work at home or at another location remote from the location of the customer computer network 10 or the location of one of the nodes 14, 16 and 18, the user removes a selectable number of units, referred to as “customer computer network remote units” and “ASP network remote units”, from the available units on the customer computer network 10 and the ASP network 15A, etc. The customer computer network remote units are the number of licensed units which are available to the disconnected user at the remote location to execute digital content licensed to the customer or otherwise copied to or made available to the disconnected user. The ASP remote units are the number of licensed units available to the disconnected user at the remote location to execute digital content licensed to the customer on the ASP network 15A, 15B, etc.

A license manager, such as license manager 60, is copied as a remote license manger for the remote user to control licensing of the remote unit by the user on his own computer which then appears to act as a totally disengaged or separate terminal from the nodes 14, 16 and 18 in the customer computer network 10 in FIG. 1. Licensing by the remote user can be either via stacking, leveling or combinations thereof as described above. It should be noted that checking out of a certain number of remote units by the disconnected user will reduce the total number of available units for the other users on the customer computer network 10.

The remote user may also wish to execute some or all of the digital content in the program suite which the user has taken from the customer computer network 10 on the application service provider computer network 15A, 15B, etc. During the initial disconnection of the user from the customer computer network 10, a flag will be provided for the remote user of its relationship to the customer computer network 10. In this manner, when the remote user sends an inquiry to the ASP 15A, 15B, etc. for execution of digital content on the ASP computer network, the ASP license manager 50 will recognize the parent/child relationship between the remote user and the customer computer network 10.

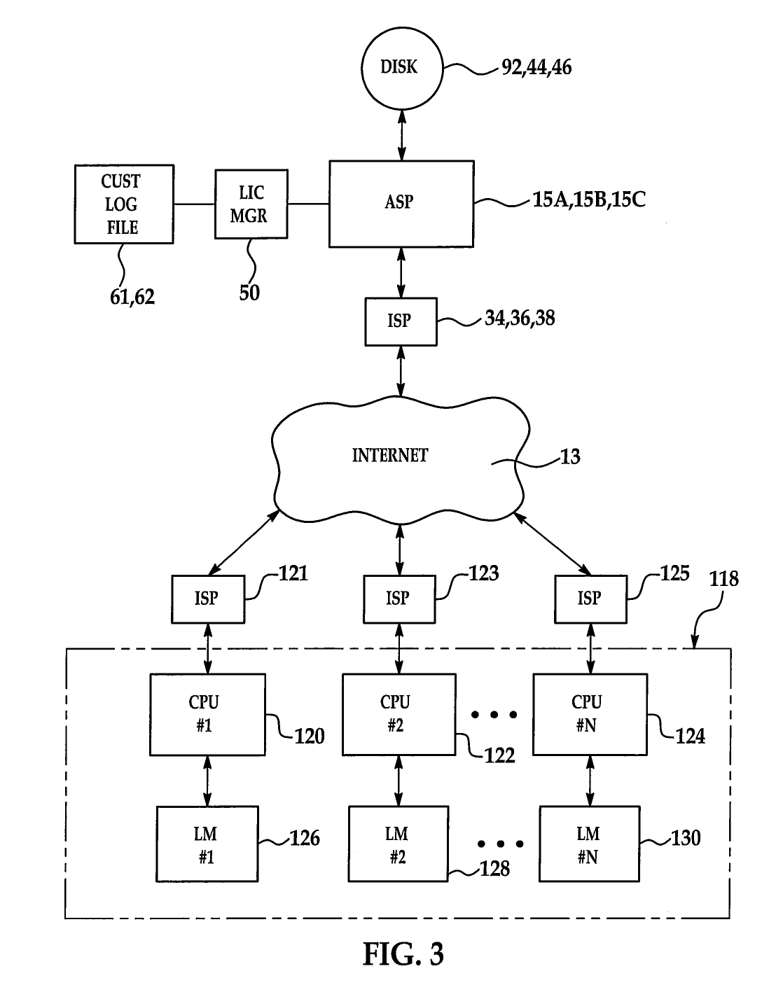

All inquiries and/or interaction between the disconnected user and the ASP network 15A, etc., will be handled in the same manner as described above and shown in FIG. 3 as if the remote user were still connected to the customer computer network 10. That is, the remote user will be subject to the available units for the customer computer network 10 when requesting the execution of digital content on the ASP network.

Referring now to FIG. 3, there is depicted a similar arrangement of a customer computer network denoted here by reference number 118 which communicates through a global telecommunication network, such as the Internet 13, to an application service provider or ASP 15A, 15B, 15C, etc., in the same manner as described above and shown in FIGS. 1 and 2.

However, in this arrangement, the single customer computer network 118 is formed of a number of individual CPUs 120, 122 and 124, for example only. Each CPU 120, 122 and 124 has its own individual license manager 126, 128 and 130, respectively. Each CPU 120, 122 and 124 also has access to the ASP network 15A, 15B and 15C through the Internet 13 via individual Internet service providers or ISPs 121, 123 and 125, respectively.

The individual CPUs 120, 122 and 124 may constitute three different users not normally affiliated with a business customer computer network. These users act independently and may be in different physical locations without any direct connection between the CPUs 120, 122 and 124. The users of the CPUs 120, 122 and 124 will initially join together as a group forming the customer computer network 118 by purchasing a total number of licensed units as a group. The individual license managers 126, 128 and 130 have access to each other via the Internet 13 to maintain a total number of individual checked out units and available units for each CPU 120, 122 and 124. Each license manager 126, 128 and 130 also communicates with the ASP license manager 50 for execution of the communication and control routine described above and shown in FIG. 2. The ASP license manager 50 sends updates to each license manager 126, 128 and 130 on the customer computer network 118 to provide each of the license managers 126, 128 and 130 associated with the CPUs 120, 122 and 124, respectively, with requests for locking and unlocking units.

The arrangement shown in FIG. 3 enables a number of what would normally be independent CPUs to have access to an application service provider to run the latest digital content of any type, such as application programs, video games, etc., without purchasing the actual software or video game. Each individual customer is restricted by acting as a group in terms of abiding by the number of available units before being able to access and execute digital content on the ASP network; but typically obtains access to a larger number of units than purchased individually by the customer, and consequently to larger quantities of digital content than each customer's individually purchased units would allow.

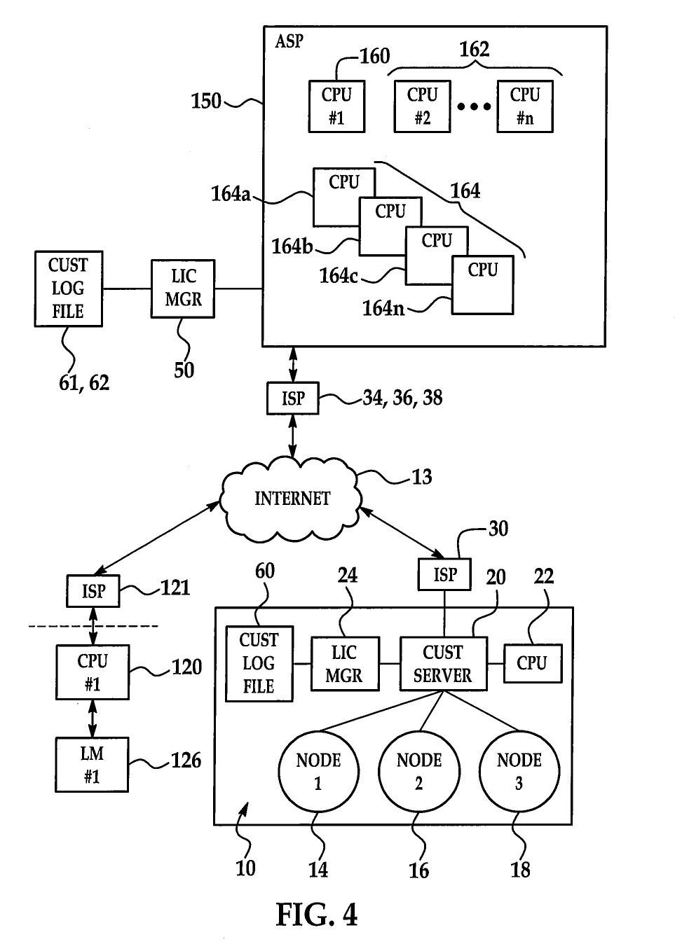

Referring now to FIG. 4, there is depicted yet another aspect of the licensing method which may be used to license computer components or hardware which are capable of executing digital content in addition to or separate from the digital content itself. This alternate licensing method may be used with an ASP as previously described. In the previous licensing management licensing examples, the ASP 15a, 15b, 15c was described as a computer network which was remotely from a customer computer or customer computer network and connectible to the customer computer or computer network through a communications network, such as the Internet. The previously described licensing methods were independent of the type of resources or equipment used by the one or more ASPs 15a, 15b, and 15c.

In this alternate licensing method, the one or more ASP, such as ASP 150, includes at least one and, typically, a plurality of computer components or hardware which can be utilized to, for example, execute, load, store, copy and/or transfer digital content, such as computer software programs, digital music, digital videos, etc. Of course, the computer components or hardware can be utilized for other suitable functions in addition to or in lieu of those listed above.

The terms used in this method are defined as follows:

Application Service Provider (ASP) Hardware Resource: Computer related hardware components, including one or more processors (e.g., central processing units (CPUs), microprocessors, graphics processing units, etc.) and/or data storage (e.g., RAM, ROM, EEPROM, hard disk, tape library, etc.). The ASP Hardware Resources can include the hardware components used by an ASP to execute, load store, transfer digital content, etc. and/or ASP supplied digital content such as software programs, digital music, digital video programs, etc. ASP resources can also be referred to at a higher level (e.g. server computer, desktop computer, laptop computer, etc). An ASP resource can also be one or more additional hardware resources to provide redundancy. Accordingly, for example, redundant hardware resources can include providing resources such that copies of a customer's data can be included on more than one computer component such as a storage device. Furthermore, an ASP hardware resource can provide alternative communication paths (e.g., between the customer or customer computer network and the ASP, between the ASP and other ASPs, etc.). Thus, for example, if the primary communication path the customer or customer computer network is utilizing fails, the customer may utilize an alternative communication path provided by the ASP. ASP hardware resources also include components that can increase bandwidth. Of course, other suitable ASP Hardware Resources are available and are not limited to those described herein.

Application Service Provider (ASP) Resource Assigned Units: The value in terms of the number of units or tokens assigned to each individual ASP resource or computer component when utilized by the customer computer or CCN. Of course, the ASP Resource Assigned Units can be assigned at anytime before utilization and are not necessarily assigned at the time of utilization by the customer computer or CCN. The number of ASP Resource Assigned Units or tokens can pay for, for example, execution of a piece of digital content on a single ASP hardware component or simultaneously on a plurality of ASP hardware components. The number of ASP Resource Assigned Units or tokens may include premiums or a multiplier of the pre-assigned number of units or tokens for priority use or execution of a particular ASP Hardware Resource based on time of day and/or day of week or any other suitable factor.

Licensed Units: The total number of units or tokens provided to the customer. The Licensed Units may be provided to the customer under, for example, a license agreement to utilize one or more hardware resources and/or a license agreement to execute digital content. The Licensed Units may also be provided in any other suitable manner that may or may not require a license agreement. The Licensed Units may be provided as a single pool of Licensed Units used to execute digital content using the ASP hardware resource and/or to utilize the ASP hardware resource in another manner. Alternatively, the Licensed Units may be provided as separate licensed unit pools specifically assigned to, for example, execution of certain digital content and/or utilization of certain ASP hardware resources.

As shown in FIG. 4, the ASP 150 can include at least one and typically a plurality of independently useable ASP Hardware Resources, such as a computer component 160 which may be a single central processing unit (CPU #1), a plurality of individual central processing units 162 (CPU #2-CPU#n) and/or a single CPU 164 which includes processors 164a, 164b, 164c-164n which are configured for parallel, simultaneous operation to execute digital content. Referring again to FIG. 4, each CPU may include one or more individual processors. The central processing units 160 and 162 may be included in supercomputers, work stations, servers, desktop computers, lap top computers etc.

Supercomputers can include, for example hundreds or thousands of independent, parallel configured processors. In contrast, the parallel operation of CPUs 164a-n can process a smaller capacity with, for example, two, three, four or more processors configured for simultaneous parallel execution of parallel configured software. The ASP resources may also include a single CPU 164 which includes processors 164a, 164b, 164c-164n which are configured for parallel, simultaneous operation to execute digital content, such as computer software, which is itself configured for parallel execution.

Of course, although this embodiment has been and will continue to be described with reference to ASP Hardware Resources being CPUs, embodiments of the present invention are not limited to this example. In contrast, embodiments of the present invention can include, as discussed previously, any and all types of hardware resources (e.g. data storage, redundant components etc.). Further, although the ASP Hardware Resources are shown as all located within the ASP 150, ASP Hardware Resources may be located at separate locations from one another or at a location separate from the ASP itself. For example, ASP Hardware Resources may be located external to the ASP 150 and are not necessarily physically located within the ASP. As long as ASP 150 (or an entity within the control of ASP 150) can provide a minimum level of control over the ASP Hardware Resource, the ASP Hardware Resource can be considered to be part of the ASP 150 regardless of whether the hardware component is fully or partially located at the ASP or at another location.

It will be understood that although the following description of the alternate licensing method using the computer configuration shown in FIG. 4 describes the use of computer resources at an ASP, the same licensing method may be employed in an individual customer network by using customer network computer hardware resources rather than remotely located ASP hardware resources.

The ASP assigned resource units may also take into account information which corresponds to, for example, a measure of power and/or performance of the hardware resource or computer component. For example, a number of million services units (MSU) or a number of MIPS (million instructions per second) are general measures of computing performance, and by implication, the amount of work a computer can do.

Each individual computer or ASP hardware component 160, 162, 164, etc, is preassigned with a predetermined number of ASP assigned resource units. The ASP assigned resource units may have any assigned value or number of units or tokens. The number of units or tokens for each ASP hardware component may be the same or may vary depending upon any one of more of a number of factors, including the type of hardware component, its processing power, its operating speed, its capacity, its purchase cost, the cost of maintenance and operation, including hardware and software operating system updates, customer need, identity of requesting customers, geographic location of customers, parallel processor capability, time of day, and day of week use considerations or some combination thereof. Of course, other factors are available that may be taken into account to calculated the ASP resource assigned units.

By way of example only, the ASP hardware component 160 labeled CPU #1 may be, as discussed previously, a supercomputer. The individual hardware components 162 may be individual computer processor work stations, desktop computers, laptop computers, etc. As described above, the ASP hardware component 164 is a single computer component having multiple parallel processors 164a-164n configured for simultaneous parallel execution of parallel configured digital content.

In the following examples, which are provided for clarification, but not limitation of the licensing method, the ASP resource hardware component 160, referred to above as a “supercomputer,” will be preassigned 50 ASP assigned units or tokens. The individual CPU components 162 will have an ASP assigned unit value of 5 units of tokens. Each individual parallel processor 164a, 164b, 164c, 164n, with four parallel processors being shown by way of example only for the component 164, will have an ASP assigned unit value of 5 units or tokens.

It is known that certain types of digital content may require the exclusive use of a supercomputer such as the ASP hardware component 160. Other digital content may be useable on or incapable of being used on the parallel configured processor component ASP hardware component 164. There may also be differentiation between the capabilities, speed and mode of operation of the individual components 162 which make each component 162 optional for executing certain digital content.

It may be typical for the ASP 150 to be capable of executing digital content and/or permit utilization of the ASP hardware resource from multiple customers or customer networks. This may limit immediate access to any individual ASP hardware resource/component. This factor, for example, when coupled with specific hardware operating capabilities required by each piece of digital content, may require the ASP 150 to modify the ASP assigned resource units for each component of ASP hardware 160, 162, 164 to accommodate immediate or premium execution of digital content on a specific ASP hardware component, or in view of time of day or day of week execution considerations, etc. Further, the ASP 150 may modify the ASP assigned resource units based on any other suitable factor (e.g. cost, need, etc.).

The licensing method used by the license manager 50 may be exclusively for licensing of the ASP hardware resources independent of which piece of digital content is being executed on each ASP hardware resource. Alternatively, the licensing method used by the license manager 50 may be involved with some other factor, such as storage, backup, and/or communication or some combination thereof (including execution) using the ASP hardware resource. The licensing method may also involve the licensing of individual components of the ASP hardware in conjunction with the licensing of each piece of digital content executed or run on such ASP components.

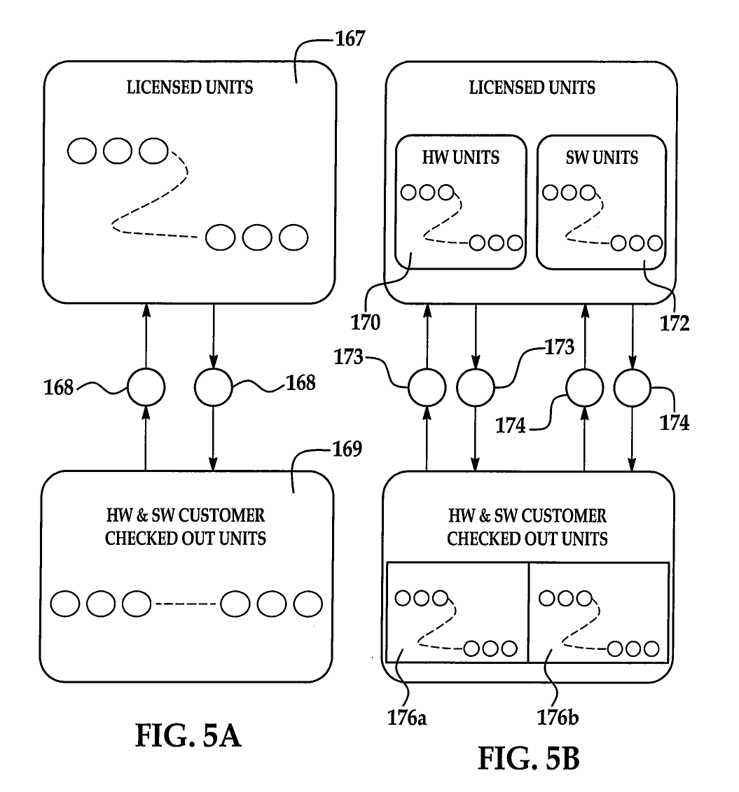

The following example assumes that one piece or work of digital content requested by one customer may be executed on any of the individual components of the ASP hardware 160, 162, 164, etc. Referring to FIG. 5A, this example also assumes that the licensed units provided to the customer are in one license pool 167. Accordingly, the units in the license pool will be applicable to and usable for the ASP assigned resource hardware units and the ASP required units for the digital content. Units 169 can be transferred to and/or from (need not be an actual physical transfer) a group of units 169 representing the number of units that have been checked out by a customer.

In this example, the ASP required units for execution of a requested piece of digital content, such as one software program, will be 25 licensed units or tokens. The license method employed by the license manager 50 can use the licensed units or tokens according to any licensing methodology, such as stacking, the previously described leveling, one time use, etc. This licensing methodology may also be employed entirely or in part by a license manager 24 at the customer computer network 10.

In this example, the total licensed units or tokens, which can be added to the total number of customer checked out units (e.g. in a stacking licensing scheme) when execution of the digital content and/or utilization of the ASP hardware resource is allowed by the license manager 50, that are required to execute the one requested digital content on a selected ASP component can be calculated according to the following formula:

Number of ASP assigned hardware units×number of ASP hardware components required+ASP required software units=total required units. Alternatively, each of the ASP assigned hardware units for each individual hardware resource can be summed separately (i.e. CPUs 164a-n added to total required units individually).

### Example A

| | | | No. | | ASP | | TOTAL |
|---|---|---|---|---|---|---|---|
| USE | HW | | CPU's | | SW | | REQ'D |
| COMPONENT | UNITS | × | REQ'D | + | UNITS | = | UNITS |
| CPU 160 | 50 | × | 1 | + | 25 | = | 75 |
| CPU 162 | 5 | × | 1 | + | 25 | = | 30 |
| CPU 164 | 5 | × | 4 | + | 25 | = | 45 |

The larger capacity, more expensive supercomputer component 160, for example, can require the greatest number of licensed units or tokens for execution of digital content or utilization of the ASP hardware resource. The less expensive, individual hardware components 162 generally have a low license cost and therefore can require the lowest number of total hardware units or tokens. The multi-processor parallel operating component 164 can require an intermediate number of tokens due since its cost and operating capabilities can be greater than that of the individual CPU's 162, but less than that of the supercomputer 160.

Licensed units may be employed against the ASP assigned resource units for ASP hardware or only ASP software units or in a separate hardware pool 170, and a separate software pool 172 of licensed units, as shown in FIG. 5B. Accordingly, the units in the license pool 170 will be applicable to and usable for the ASP assigned resource hardware units and the units in the license pool 172 will be applicable to and usable for the ASP required units for the digital content. Units 173 can be transferred to and/or from (need not be an actual physical transfer) a group of units 176a representing the number of units that have been checked out by a customer related to the ASP hardware resources and units 174 can be transferred to and/or from (need not be an actual physical transfer) a group of units 176b representing the number of units that have been checked out by a customer related to the required units for the digital content.

In this case, the above example is modified as follows:

### Example B

| USE | | No. CPU'S | TOTAL REQ'D |
|---|---|---|---|
| COMPONENT | HW UNITS × | REQ'D = | UNITS |
| CPU 160 | 50 × | 1 = | 50 |
| CPU 162 | 5 × | 1 = | 5 |
| CPU 164 | 5 × | 4 = | 20 |

Not only do the individual ASP hardware components 160, 162 and 164, for example, have different digital content execution cycle times, each piece of digital content itself can require a different amount of time for a complete execution or run depending upon the amount of input data supplied with each piece of digital content or the complexity of the digital content itself. Thus, it is possible to take into account the ASP resource use or run time by itself, the digital content execution or run time itself, or a combination of ASP resource and digital content run time.

As in the previous example, the following example presumes the execution of a single piece of digital content by the ASP 150 in response to a customer request on any of the individual ASP resources or hardware components 160, 162 or 164. For example, due to its higher operating speed and capacity, the supercomputer 160 may complete execution of one work of digital content in one hour. An individual CPU 162 may take 12 hours to complete execution of the same digital content work. The parallel configured ASP hardware component 164 may take two hours to complete execution of the same digital content.

### Example C

| USE | | | NO | | | | TOTAL |
|---|---|---|---|---|---|---|---|
| COM- | HW | | CPU'S | | EXECUTION | | UNIT * |
| PONENT | UNITS | × | REQ'S | × | HOURS | = | HOURS |
| CPU 160 | 50 | × | 1 | × | 1 | = | 50 |
| CPU 162 | 5 | × | 1 | × | 12 | = | 60 |
| CPU 164 | 5 | × | 4 | × | 2 | = | 40 |

The low ASP assigned resource unit individual ASP hardware component 162 may require many more hours to complete execution of digital content than components 160 and 162, thereby resulting in a higher hardware unit*hour total.

Execution of the digital content in terms of total execution unit*hour s can also be calculated according to the same hardware usage execution cycles.

### Example D

| DIGITAL CONTENT | EXECUTION | TOTAL |
|---|---|---|
| ASSIGNED UNITS × | HRS = | UNIT*HOURS |
| 25 × | CPU 160 (1 hr) = | 25 |
| 25 × | CPU 162 (12 hrs) = | 300 |
| 25 × | CPU 164 (2 hrs) = | 50 |

In this example, although the ASP assigned resource units for use of the supercomputer 160 is significantly higher than the assigned units of the other components 162 or 164, its substantially higher operating speed and power results in a reduced unit*hours total. The slower operating speed and power of the individual hardware component 162 requires 12 hours of software execution time resulting in a total of 300 unit*hours.

The hardware unit*hours and the software unit*hours may be used individually or combined into a total number of hardware and software execution unit*hours.

Of course, the pre-assignment of different assigned units to each ASP hardware component and different assigned units to each piece of digital content executed on such ASP hardware components can result in different ASP hardware units and ASP software unit requirements.

The hardware and/or software unit*hour totals for execution of each piece of digital content by the ASP 150 for a customer can be used in a number of different ways. In one instance, the total hardware and/or software execution totals for each individual piece of digital content can be totaled for the billing period, such as for each month, quarter, etc., and the totals used to return a portion of the license units fees paid by the customer for the billing period to the source of each digital content based on a pro-rated total hours of use of each digital content.

The License Units, the Assigned Units, the Required Units and the Checked Out Units in the various examples of the licensing method when used with the above-described leveling licensing approach, may be redefined in terms of unit*hours or token*hours reflective of ASP hardware and software execution or utilization times. This may be a more accurate representation of the actual amount of ASP resources used by each customer when executing each piece of digital content on any selected ASP hardware component and/or utilizing the ASP hardware components for other tasks as described above.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for licensing at least one hardware resource for use by a customer computer, the at least one hardware resource provided by an application service provider (ASP) distinct from the customer computer, the method comprising:
providing licensed units to a customer;
assigning a predetermined number of ASP assigned hardware units to the at least one hardware resource; and
determining whether the customer can utilize the at least one hardware resource based on the licensed units provided to the customer and the ASP assigned hardware units for the assigned to the at least one hardware resource.

2. The method of claim 1, wherein assigning the predetermined number of ASP assigned hardware units further comprises:
assigning ASP assigned hardware units to each of a plurality of hardware resources.

3. The method of claim 2, wherein assigning ASP assigned hardware units to each of the plurality of hardware resources further includes:
assigning different numbers of assigned ASP hardware units to each of at least two distinct hardware resources.

4. The method of claim 1, wherein the at least one ASP resource includes a plurality of independently operable processors for simultaneously executing digital content.

5. The method of claim 1, wherein the at least one hardware resource is at least one of a processor, data storage component, redundant component, alternative communication path component and a bandwidth component.

6. The method of claim 1, wherein the step of assigning ASP assigned hardware units to the at least one hardware resource further comprises:
varying the number of ASP assigned hardware units assigned to the at least one hardware resource based on at least one of the time of day of use, the day of the week of use, and immediate use of the at least one hardware resource.

7. The method of claim 1, wherein at least one of the CCN and the ASP provide independently selectable digital content, the method further comprising:
assigning a predetermined number of ASP assigned digital content units to each independently selectable digital content when digital content is run by the application service provider.

8. The method of claim 7 further comprising:
determining whether a requested digital content is to be executed on the at least one hardware resource based on the licensed units provided to the customer and the ASP assigned digital content units for the selected digital content to be executed on the ASP resource.

9. The method of claim 1, wherein the step of providing licensed units, further comprises:
providing a combined group of licensed units to the customer, the combined group having units useable for both execution of digital content and utilization of ASP hardware resources.

10. The licensing method of claim 1, wherein the step of providing licensed units, further comprises:
providing a first group of units and a second group of units distinct from the first group, the first group having units useable specifically for execution of digital content and the second group having units specifically for utilization of ASP hardware resources.

11. The method of claim 1, wherein the at least one hardware resource includes a plurality of hardware resources, the method further comprising:
receiving a request from the customer to utilize at least one of the plurality of hardware resources.

12. The method of claim 10, wherein the request to utilize includes at least one of a request to execute selected digital content, a request to store digital content, a request to load digital content, a request to copy digital content, and a request to transfer digital content.

13. For use in a customer computer network (CON) having at least one node capable of executing digital content on at least one of the CCN and an application service provider (ASP), the ASP providing at least one hardware resource, a licensing method comprising:
providing licensed units to a customer;
assigning a predetermined number of ASP assigned hardware units to the at least one hardware resource;
charging a number of checked out units to the CCN based on ASP hardware resources currently being utilized by the customer;
receiving a request to utilize a hardware resource provided by the ASP;
determining a number of available units equal to the difference between the total licensed units to the customer and the total checked out units charged to the CCN; and
determining whether the requested hardware resource is to be utilized based on the difference between the available units on the customer computer network requesting the hardware resource and ASP assigned hardware units of the requested hardware resource.

14. The method of claim 13, wherein assigning the predetermined number of ASP assigned hardware units further comprises:
assigning ASP assigned hardware units to each of a plurality of hardware resources; and
assigning different numbers of assigned ASP hardware units to each of at least two distinct hardware resources.

15. The method of claim 13, wherein the at least one ASP resource includes a plurality of independently operable processors for simultaneously executing digital content.

16. The method of claim 13, wherein the at least one hardware resource is at least one of a processor, data storage component, redundant component, alternative communication path component and a bandwidth component.

17. The method of claim 16, wherein the processor is one of a supercomputer, a central processing unit and a plurality of independently operable central processing units

18. The method of claim 1, wherein at least one of the CCN and the ASP provide independently selectable digital content, the method further comprising:
assigning a predetermined number of ASP assigned digital content units to each independently selectable digital content when digital content is run by the application service provider.

19. The method of claim 18 further comprising:
determining whether a requested digital content is to be executed on the at least one hardware resource based on the licensed units provided to the customer and the ASP assigned digital content units for the selected digital content to be executed on the ASP resource.

20. The method of claim 1, wherein the at least one hardware resource includes a plurality of hardware resources, the method further comprising:
receiving a request from the customer to utilize at least one of the plurality of hardware resources.

21. The method of claim 10, wherein the request to utilize includes at least one of a request to execute selected digital content, a request to store digital content, a request to load digital content, a request to copy digital content, and a request to transfer digital content.

22. For use in a customer computer network having at least one node capable of executing digital content on at least one of the customer computer network (CCN) and an application service provider (ASP) providing at least one hardware resource, a licensing method comprising:
providing licensed units to a customer;
providing independently selectable digital content;
assigning a predetermined number of ASP assigned hardware units to the at least one hardware resource;
charging a number of checked out units to the CCN at least based on ASP hardware resources currently being utilized to run digital content on the ASP;
receiving a request to utilize a hardware resource provided by the ASP to execute a selected digital content;
determining a number of available units equal to the difference between the total licensed units to the customer and the total checked out units charged to the CCN; and
determining whether the requested hardware resource is to be utilized or denied utilization based on the difference between the available units on the customer computer network requesting the hardware resource and the ASP assigned hardware units of the requested hardware resource.
